(19) United States
(12) Patent Application Publication
(10) Pub. No.: US 2006/0197867 A1
(43) Pub. Date: Sep. 7, 2006

(54) Imaging head and imaging system

(76) Inventors: Peter Johnson, Milsons Point (AU); Mark Pfitzner, Glenside (AU); Simon Ratcliffe, Glenside (AU); James Howarth, Glenside (AU)

Correspondence Address: CANTOR COLBURN, LLP, 55 GRIFFIN ROAD SOUTH, BLOOMFIELD, CT, 06002, US

(21) Appl. No.: 11/070,685

(22) Filed: Mar. 2, 2005

(51) Int. Cl. H04N 5/225; H04N 5/232

(52) U.S. Cl. 348/373; 348/207.99

(57) ABSTRACT

An imaging head for an imaging system and a method of obtaining a three-dimensional image with the head and system. The imaging head consists of a digital camera and laser rangefinder fixedly aligned on a common boresight. A rotation stage rotates the camera and rangefinder together as they acquire range and image data of a selected scene. The data is combined to produce the three-dimensional image without the need for a separate calibration process. The method alows a low resolution scan to be made of a scene and an area to be selected for a high resolution scan. The method also allows a number of scans from different positions to be knitted into a single image to overcome line-of-sight limitations.

This invention relates to an imaging head for an imaging system that integrates a panoramic digital camera and a laser rangefinder to produce a three-dimensional image of a scene. In particular, it relates to an imaging system that accurately overlays a three dimensional point cloud from the laser rangefinder with a colour image from the panoramic digital camera.

### BACKGROUND TO THE INVENTION

Panoramic cameras have been available for many years. Typically these have been frame cameras that produce a series of images that are stitched together to produce the panoramic image. These cameras can produce 360° images but generally images with a lesser angular extent are produced. The production of the panoramic images involves significant processing if the camera is film based but recently CCD (charge coupled device) chips have become available to replace the film. If a large array CCD is used the camera operates by imaging a series of frames and digitally stitching the frames together, much in the way of the film cameras. However, large array CCD chips are expensive so a more suitable approach has been to use a linear array and scanning optics to build an image from a series of lines. The panoramic image is then formed from the line images that result from scanning an aperture vertically and horizontally.

The known panoramic cameras have been used with laser rangefinders to produce three-dimensional images of a scene. Scanning laser rangefinders have been known for a number of years for use in surveying and other applications. The laser rangefinder operates by scanning a laser beam across a predetermined pattern on an object and capturing the back-reflected laser radiation. The ranges and scanning angles are measured and combined to produce a three-dimensional coordinate set, sometimes referred to as a point cloud. It is typical for vertical scanning to be optical using a rotating mirror and horizontal scanning to be mechanical.

Combination of the digital images from the panoramic camera and the point cloud from the laser rangefinder has been by post processing of the independently acquired images. Typically the digital image and the range data are acquired at different times and combined later at a different location. Some devices, such as the Riegl LMS-Z420i, use a conventional digital camera and a rangefinder to acquire the digital image and range data virtually simultaneously but still require the user to perform a manual calibration step when the device is assembled because the camera and rangefinder are not integrated in a purpose built imaging head.

In order to achieve coordinate registration of the digital image and the range data the prior art approach has been to place known targets in the field of view and to use correcting software. This process is time consuming. Even with devices such as the Riegl LMS-Z420i targets must be placed for coordinate registration.

### OBJECT OF THE INVENTION

It is an object of the present invention to provide an integrated three dimensional imaging system incorporating a panoramic digital camera and laser rangefinder.

Further objects will be evident from the following description.

### DISCLOSURE OF THE INVENTION

In one form, although it need not be the only or indeed the broadest form, the invention resides in an imaging head of an imaging system comprising:
a frame;
a rotation stage rotatable on the frame;
a motor mounted to the frame and controllable to rotate the rotation stage;
a laser rangefinder mounted on the rotation stage for rotation with the rotation stage; and
a digital camera mounted on the rotation stage for rotation with the rotation stage;
wherein the digital camera and the laser rangefinder are fixedly aligned on a common boresight.

In a further form the invention resides in an imaging system comprising an imaging head and control means;

the imaging head comprising:

a frame;
a rotation stage rotatable on the frame;
a motor mounted to the frame and controllable to rotate the rotation stage;
a laser rangefinder mounted on the rotation stage for rotation with the rotation stage; and
a digital camera mounted on the rotation stage for rotation with the rotation stage;
wherein the digital camera and the laser rangefinder are fixedly aligned on a common boresight; and
   the control means performing the steps of:
sending signals to the motor to rotate the rotation stage;
receiving a digital image of a scene from the digital camera; and
receiving range data of the scene from the laser rangefinder;
   the control means including imaging software that constructs a three dimensional point cloud from the range data, overlays the digital image from the digital camera, and displays a rendered three dimensional image of the scene on a display device.

Preferably the digital image and the range data are obtained simultaneously from the digital camera and the laser rangefinder.

### BRIEF DETAILS OF THE DRAWINGS

To assist in understanding the invention preferred embodiments will now be described with reference to the following figures in which:

FIG. 1 shows an imaging head of an imaging system;

FIG. 2 shows a front view of the imaging head of FIG. 1;

FIG. 3 shows a side view of the imaging head of FIG. 1;

FIG. 4 shows a sketch of the imaging head displaying boresighting;

FIG. 5 is a block schematic of the imaging system;

FIG. 6 is a block schematic of the camera;

FIG. 7 is a block schematic of the rangefinder;

FIG. 8 is a flowchart depicting the operation of the system;

FIG. 9 is a sample scene acquired with the camera;

FIG. 10 is the same scene acquired with the laser rangefinder; and

FIG. 11 is the rendered scene combining the camera data and the range data.

### DETAILED DESCRIPTION OF THE DRAWINGS

In describing different embodiments of the present invention common reference numerals are used to describe like features.

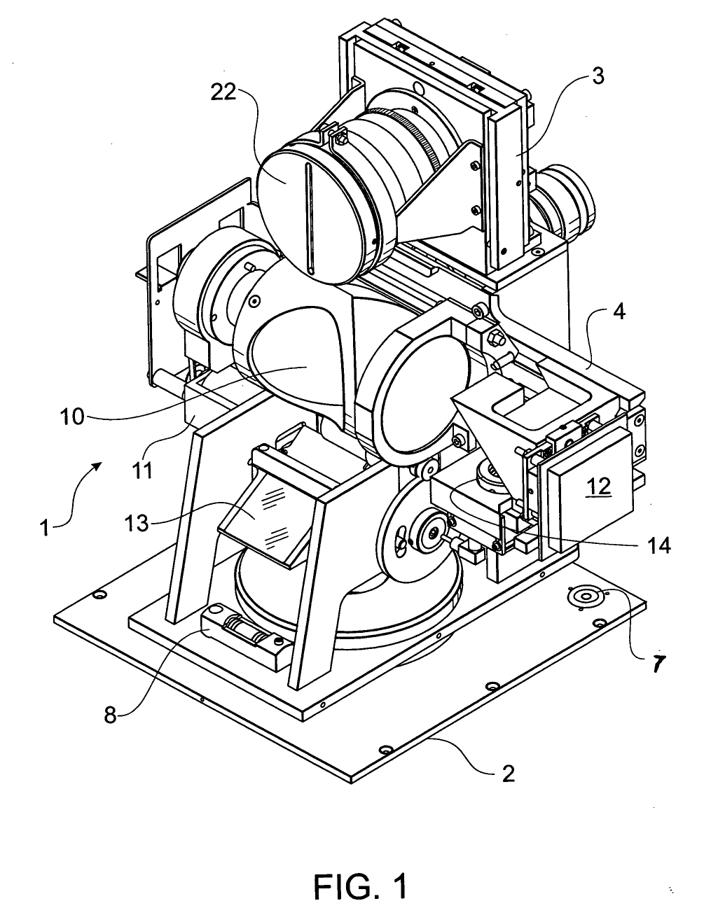

Referring to FIG. 1, there is shown an imaging head generally indicated as 1. The imaging head includes a frame 2 which is suitably mounted on a tripod or other relocatable mount. There will normally be a cover attached to the frame but this has been omitted from FIG. 1 for clarity.

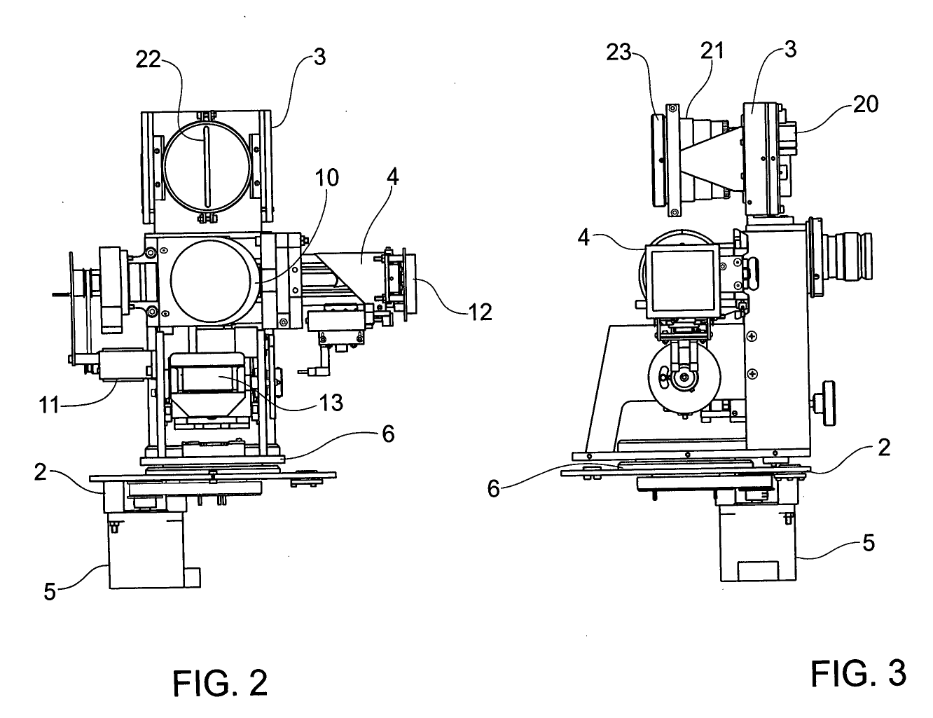

The imaging head 1 has three primary elements being a digital camera 3, laser rangefinder 4, and stepper motor 5. The stepper motor 5 is mounted to the frame 2 and supports a rotation stage 6, seen most clearly in FIG. 2 and FIG. 3. The frame is leveled using center level 7. A bubble level 8 provides greater accuracy.

The laser rangefinder 4 includes a rotating mirror 10 that is rotated around a horizontal axis by motor 11. A beam from laser 12 is scanned in a vertical plane by the rotation of the mirror 10. Reflected radiation is also collected at mirror 10 and directed to a photodiode 14. A signal from the photodiode 14 is processed by control electronics to obtain range data. A typical laser rangefinder operating in this configuration can scan a field of view of 80° vertically and 360° horizontally up to a range of 400 m at a rate of over 4000 measurements per second.

The digital camera 3 is formed by a linear CCD array 20 aligned parallel to the axis of rotation of the camera 3. That is, the linear CCD array 20 is aligned substantially vertically with the camera 3 rotating horizontally with the rotation stage 6. The CCD array 20 comprises three parallel linear sets of pixel sensors, one fitted with a filter for red, one for green and one for blue. These lines of pixels are arranged parallel with a small separation between each line. A scene is imaged onto the CCD array by imaging optics 21. A slit 22 limits the field of view of the camera. This arrangement means that the each line of pixels is illuminated by a different image from the lens. Hence, a different position in space is imaged by each colour in the sensor. The electronic and mechanical control of the rotation of the stage 6 is synchronized so that each line of colour pixels records the same image by exposing the pixels at appropriate times during the rotation.

The angular offsets for each line of pixels are easily calculated from the known separation of the pixel lines on the CCD chip and the lens characteristics.

The digital camera 3 and laser rangefinder 4 acquire data simultaneously and synchronously. An optical filter 23 is used to present only visible light to the pixels of the digital camera. The lens distortion of the imaging optics of the camera is measured and corrected to ensure the longitudinal angular dispersion of the pixels is constant and matched with the dispersion of points in the range image. This assists with correctly matching objects in the visual image with the range data. If there was a significantly different angular dispersion an object in the far field may appear narrow and short in the point cloud but broad and long in the digital image.

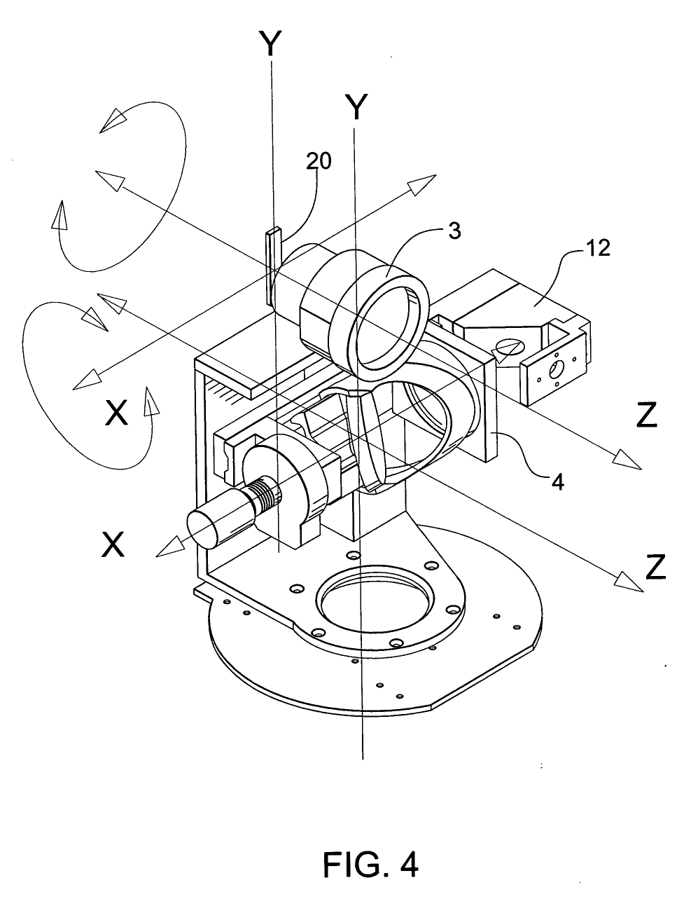

The optical alignment of the pixel lines is arranged so that at any instant the center (green) line of pixels is aligned with the vertical scanning plane of the laser rangefinder. The orientation of the linear CCD array 20 is controlled in two axes, as shown in FIG. 4, to ensure the lines of pixels are parallel with the laser scan vertical plane, and to ensure that all pixels lie in the focal plane of the lens.

As seen in FIG. 4 the Z axis of the laser is aligned with the Z axis of the camera by lateral translation of the laser collimating lens and the orientation of CCD array 20 is adjusted to match. The fixed offset between the laser Z axis and the camera Z axis is known, as is the distance from the linear CCD array to the objects being imaged. With this information and the range to each point as recorded by the laser rangefinder, the parallax error is corrected. Parallax error would have the effect of separating points in the digital image from points in the range point cloud up to a limit equal to the separation between the respective Z axes as the range to an imaged object approached zero.

As mentioned above, the center line of pixels in the CCD array is aligned to the laser vertical scan line. In order to build a colour image each line must be exposed to the same image. To achieve this the rotation stage 6 is stepped the appropriate angular distance to move the vertical line image onto the next line of pixels. The horizontal angular separation of the laser scans is then fixed to an integer multiple number of steps. A multiple of one gives one range line per RGB image line. A multiple is chosen to give a correct image aspect ratio considering the number of pixels in each vertical line and the desired field of view. For an 800 field of view and a typical linear CCD array such as an NEC Integrated Circuit uPD3799 is (which typically has a considerably larger vertical separation between pixels than horizontal separation between pixel lines) a suitable multiple is three.

For example, if a multiple of one is used the following sequence of operational events occur:

1. Image data is collected from the red CCD pixels;

2. Image data is collected from the green CCD pixels at the same vertical plane and a line of range data is recorded;

3. Image data is collected from the blue CCD pixels at the same vertical plane.

For a multiple of three there are another two imaging steps between each of these steps where pixel images are recorded at different horizontal angles.

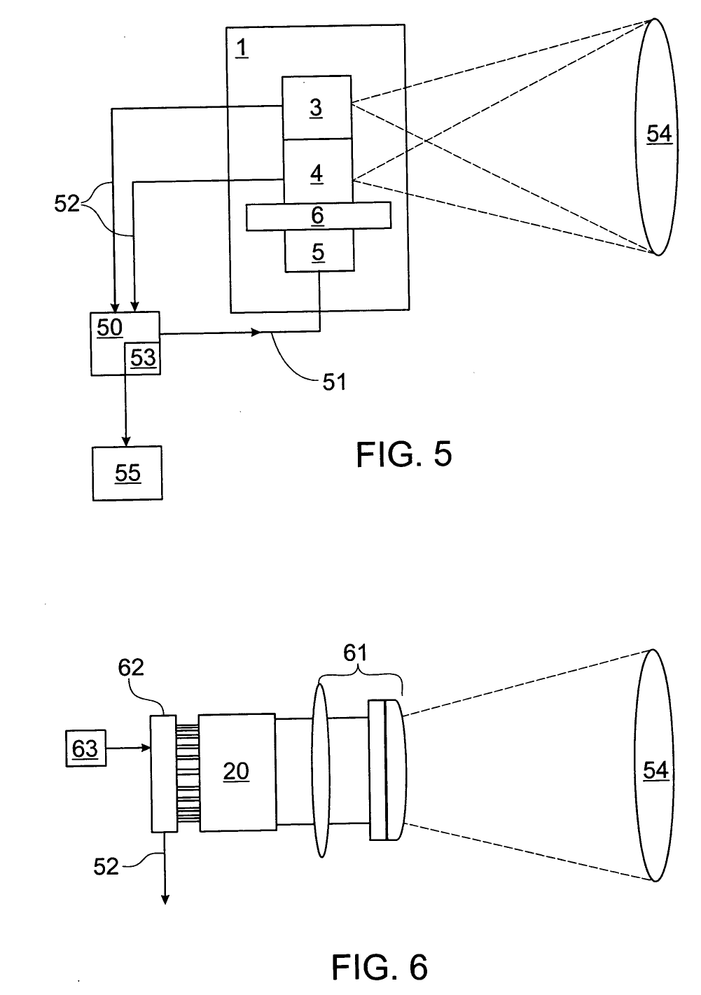

FIG. 5 shows a schematic of an imaging system incorporating the imaging head described with reference to FIGS. 1-4. A control means 50 is in signal connection with the imaging head 1. Signals from the control means 50 are sent to the stepper motor 5 on signal line 51 to control the steps and hence rotation of the rotation stage 6 with the camera 3 and laser rangefinder 4. The control means 50 receives data from the camera 3 and rangefinder 4 on data bus 52. The control means 50 is conveniently incorporated in two parts. All system control is by on-board control system. The operator controls parameters for the complete image via an external part of the control means but these are restricted to be within possible system operating conditions.

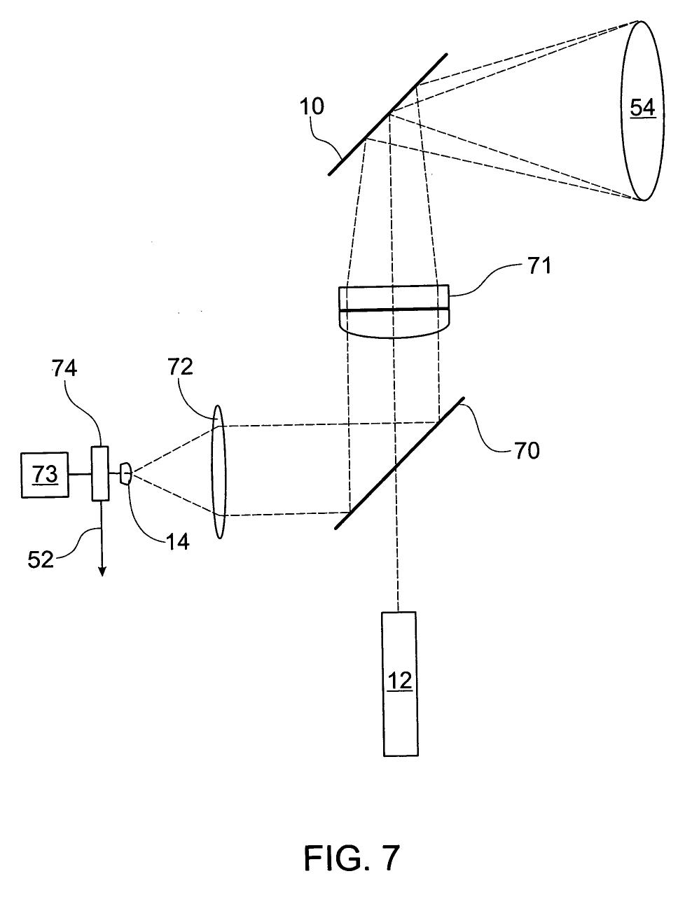

The data can be collected from the camera 3 and rangefinder 4 in any suitable way. Examples of embodiments found suitable by the inventors are shown in FIG. 6 and FIG. 7.

Referring to FIG. 6, an image of the scene 54 is directed by optical arrangement 61 to CCD array 20. Data from each pixel of the array 20 is loaded into a shift register 62 which is transmitted serially on data line 52 according to a clocking signal from clock 63 which may be local, synchronized to the stepper motor drive signal 51 or otherwise originating from the control means 50.

Referring to FIG. 7, a similar arrangement applies to the rangefinder 4. The laser 12 directs a beam through apertured mirror 70 to rotating mirror 10. Lens 71 collimates the return scattered radiation which is directed by mirror 70 and optics 72 to photodiode 14. Data from the photodiode 14 is buffered in local memory 74 which transmits data on data line 52 according to clock signal 73, which may be local, synchronized to the stepper motor drive signal 51 or otherwise originating from the control means 50.

Proprietary software 53 runs in the control means 50 to perform the coordinate registration of the data obtained from the camera 3 and rangefinder 4. The image is displayed on a display 55 which may be incorporated in the control means 50 or separate. The inventors have found that a suitable control means is a Casio Hand Held Controller model MPC-710M30E Pen Tablet.

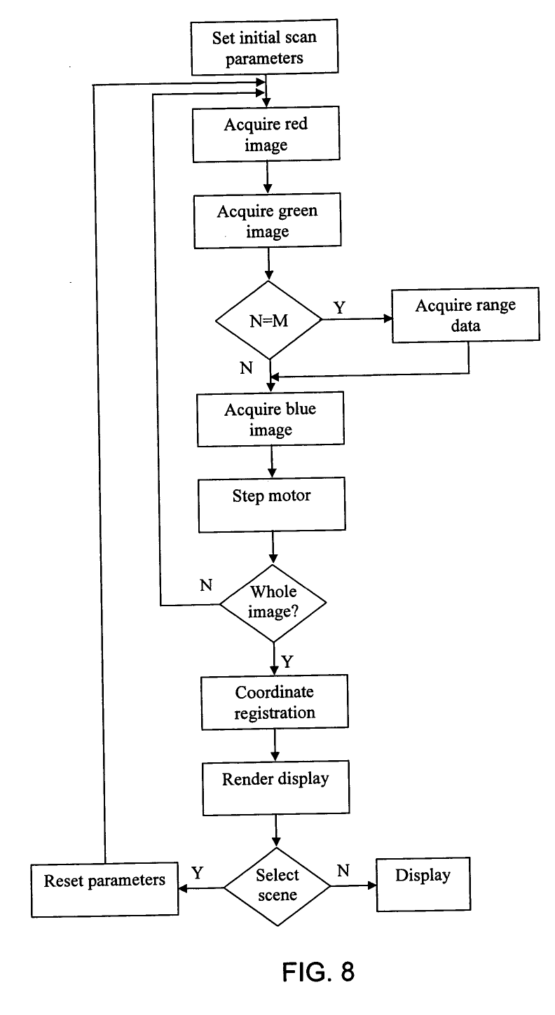

A particular advantage of the invention is the high resolution image that is obtainable and the control of the field of view. The inventors have found that a useful mode of operation is to perform an initial rapid scan to produce a low resolution image and then to use the touchscreen tablet to select a region of interest within the available scene for a higher resolution scan. The process is summarized in the flowchart of FIG. 8.

Referring to FIG. 8, the user initially sets the scan parameters including horizontal and vertical angles, range and resolution. Based upon these parameters a suitable multiple is determined for the number of image lines (M) to be acquired for each range scan (N). The red and green images are acquired, if N=M the range data is acquired, and the blue image is acquired. It will be appreciated that these steps occur virtually simultaneously. The motor then steps the calculated angle and the process is repeated until the image is acquired. Once the whole image is acquired the software 53 in the control means 50 performs coordinate registration and displays the scene. The user may then select a portion of the scene for high resolution data acquisition.

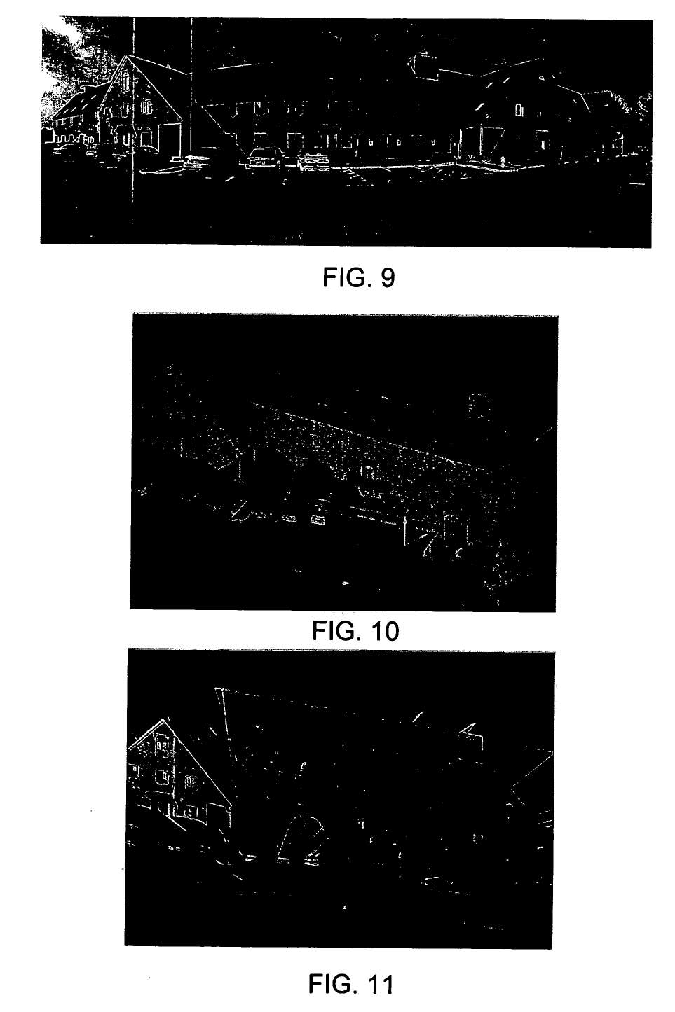

Selecting a portion of the original scene resets the scan parameters. A new scan occurs and high resolution data is acquired for the particular scene portion selected. Once the whole image is acquired, and no new scene is selected, the three-dimensional image is available for display. It is usual for the three-dimensional image data to be stored for further off-line rendering and manipulation. An example of a high resolution image recorded by the camera is shown in FIG. 9. A point cloud of the same scene as recorded by the laser rangefinder is shown in FIG. 10. The final rendered image containing complete three-dimensional data is shown in FIG. 11.

The invention can be used to rapidly and accurately construct a multi-view three-dimensional scene that is not limited by line-of-sight constraints. The addition of a theodolite and GPS allows a universal grid system to be overlaid to the imaging system so the head is positioned in a number of accurately known positions and the acquired images can be stitched together in software to allow the scene to be viewed from virtually any position. In one embodiment the imaging system includes, in the scanning head, a boresighted telescope which is controlled by the user to direct azimuth (using the stepper motor) datums of both the laser scanner and panoramic camera along a known reference bearing (usually from one control survey point to another). The coordinates of these control points are recorded and the laser scan point cloud and associated panoramic image are automatically translated and rotated to match the reference bearing. The instrument height is recorded and the instrument axes are leveled by an inclinometer integrated in the scanning head.

The invention has a number of advantages over existing systems including:
complete scanner control and integration—means there is no need to operate separate laser scanning and camera systems so the desired operation is greatly simplified and the time taken to acquire the desired data is greatly reduced. Integrated sensor control ensures the various resolutions of image and laser scan are set at matching aspect ratios for simultaneous data acquisition. No manual calibration steps need to be performed.;
control colour camera exposure levels—allows for interactive control and previewing of camera performance in a number of light levels thus saving time and avoiding guesswork during acquisition;
view of colour panoramic scan and thumbnails—allows the user to interrogate system performance thus increasing confidence in results and reducing the chance of error or omission;
link with multiple site survey station databases—facilitates direct reference of laser scans and images to global coordinate systems without common point registrations by external measurement. This increases efficiency, speed, accuracy and ease of use;
enter instrument height—allows for compensation for the height above coordinate control points of the instrument tripod and frame;
touchscreen interface—enables control of the imaging system by methods more suited to use outdoors and in harsh environments;
image data automatically registered to scan data—removes the need and time taken to register external frame or panoramic images to point clouds and increases the viewing quality of data for a variety of applications, and for verification of results. Also removes the need for users to understand the technical issues associated with photorendering 3D surfaces and the need for specialised software.

Throughout the specification the aim has been to describe the invention without limiting the invention to any particular combination of alternate features.

1. An imaging head of an imaging system comprising:
a frame;
a rotation stage rotatable on the frame;
a motor mounted to the frame and controllable to rotate the rotation stage;
a laser rangefinder mounted on the rotation stage for rotation with the rotation stage; and
a digital camera mounted on the rotation stage for rotation with the rotation stage;
wherein the digital camera and the laser rangefinder are fixedly aligned on a common boresight.

2. The imaging head of claim 1 wherein the laser rangefinder incorporates a scanning means for scanning a laser beam in a substantially vertical scanning plane and the digital camera is a linear array having a major axis aligned with the scanning plane.

3. The imaging head of claim 2 wherein the scanning plane and linear array are substantially parallel to an axis of rotation of the rotation stage.

4. The imaging head of claim 2 wherein the scanning means is a rotating mirror.

5. The imaging head of claim 1 wherein the digital camera is a linear array having three rows of pixels, one row optimized for recording light in the red part of the visible spectrum, one row optimized for recording light in the green part of the visible spectrum, and one row optimized for recording light in the blue part of the visible spectrum.

6. The imaging head of claim 5 wherein the digital camera includes imaging optics that image a scene onto the linear array.

7. The imaging head of claim 1 further comprising a filter to present only visible light to the digital camera.

8. The imaging head of claim 5 wherein the motor is a stepper motor controlled to step the rotation stage a distance equivalent to an angular separation between each row of pixels.

9. The imaging head of claim 1 having a horizontal field of view of up to 360°, a vertical field of view of up to 120° and a range of up to 800 meters.

10. The imaging head of claim 1 further comprising a telescope aligned on a common boresight with the digital camera and the laser rangefinder.

11. An imaging system comprising an imaging head and control means; the imaging head comprising:
a frame;
a rotation stage rotatable on the frame;
a motor mounted to the frame and controllable to rotate the rotation stage;
a laser rangefinder mounted on the rotation stage for rotation with the rotation stage; and
a digital camera mounted on the rotation stage for rotation with the rotation stage;
wherein the digital camera and the laser rangefinder are fixedly aligned on a common boresight; and
the control means performing the steps of:
sending signals to the motor to rotate the rotation stage;
receiving a digital image of a scene from the digital camera; and
receiving range data of the scene from the laser rangefinder;
the control means including imaging software that constructs a three dimensional point cloud from the range data, overlays the digital image from the digital camera, and displays a rendered three dimensional image of the scene on a display device.

12. The imaging system of claim 11 wherein the control means comprises a first part internal to the imaging head and a second part external to the imaging head.

13. The imaging system of claim 11 wherein system control is embodied in said first part and user manipulation and display is embodied in said second part.

14. A method of constructing a three-dimensional image of a scene including the steps of:
(i) recording a visual image of a scene by:
(a) recording a red image of a slice of a scene;
(b) recording a green image of the slice of the scene;
(c) recording a blue image of the slice of the scene;
(ii) recording range data of the slice of the scene;
(iii) repeating steps (i) and (ii) until red images, green images, blue images and range data are recorded for the scene;
compiling the red images, green images, blue images and range data into a three-dimensional image of the scene.

15. The method of claim 14 wherein the visual image and the range data are obtained simultaneously from a digital camera and a laser rangefinder.

16. The method of claim 14 wherein the visual image and the range data are obtained synchronously from a digital camera and a laser rangefinder.

17. The method of claim 14 wherein the visual image and the range data are corrected for parallax error.

18. The method of claim 14 wherein the visual image is recorded by a CCD array having three rows of pixels, each row recording one of the red image, the green image or the blue image.

19. The method of claim 18 wherein the CCD array is sequentially rotated by an amount equal to the angular separation between the rows of pixels.

20. The method of claim 14 further including the step of selecting the scene from a preview recording of a region including the scene.

21. The method of claim 20 wherein the preview recording of the region is recorded at a lower resolution.

22. The method of claim 14 further including the steps of:
constructing a three-dimensional image of a first scene recorded at a first known location;
constructing a three-dimensional image of at least a second scene recorded from at least a second known location; and
combining said three-dimensional image of the first scene with said three-dimensional image of said at least second scene to obtain a multi-view three dimensional image of said scene.

23. The method of claim 22 further including the steps of determining said first known location and said second known location is by GPS.

24. The method of claim 22 further including the step of overlying said multi-view three-dimensional image with a universal grid system.
